(19) United States
(12) Patent Application Publication
(10) Pub. No.: US 2021/0394628 A1
(43) Pub. Date: Dec. 23, 2021

(54) Modular Charging Station For Light Electric Personal Mobility Vehicles And Methods of Use Thereof

(71) Applicant: Sunvessel Corp., Miami, FL (US)

(72) Inventors: Sebastian Gomez Puerto, Coral Gables, FL (US); Michael Thompson, Bokeelia, FL (US)

(21) Appl. No.: 17/355,972

(22) Filed: Jun. 23, 2021

Related U.S. Application Data
(60) Provisional application No. 63/042,923, filed on Jun. 23, 2020.

(51) Int. Cl. B60L 53/16; H02J 7/00; B60L 53/66; B62K 11/00

(52) U.S. Cl. CPC B60L 53/16; H02J 7/0045; B60L 53/66; B62K 2204/00; B60L 2200/16; B60L 2200/12; B62K 2202/00; B62K 11/007

(57) ABSTRACT

The invention is directed systems, methods, and devices for a modular charging station configured to be expanded or retracted to accommodate and charge a variable number of light electric personal mobility vehicles, and in particular electric two-wheeled, self-balancing, non-tandem light electric personal mobility vehicles. Additional embodiments include a novel vehicle adaptor configured to be coupled to a light electric personal mobility vehicle that is further in electrical communication with the vehicle's battery therewith, that can further be coupled with a receiving dock on a modular charging station that is configured to communicate with, and electrically charge the vehicle's battery from a power supply.

### CROSS-REFERENCE TO RELATED APPLICATIONS

This U.S. Non-Provisional Application claims the benefit of and priority to U.S. Provisional Application No. 63/042,923, filed Jun. 23, 2020, the specification, claims and drawings of which are incorporated herein by reference in their entirety.

### TECHNICAL FIELD

The inventive technology generally relates to novel systems, methods and devices for identifying, tracking, coordinating, and charging light electric personal mobility vehicles.

### BACKGROUND

As the use and demand for light electric personal mobility vehicles increase, there will naturally be a need to identify, coordinate, and charge large numbers of vehicles within any given environment, whether that be located indoors in a personal or professional setting, or outdoors at recreational locations and the like. However, despite being environmentally-friendly and having a lower cost of operation, the adoption of electric light electric personal mobility vehicles by consumers still remains low. One reason for this may be so-called “range anxiety,” or the fear of not being able to complete a trip or get to a charging station due to excessive depletion of battery charge. Another problem is that it may be difficult to coordinate multiple vehicles within any given location that may all need to be charged at the same or different times. In particular, consumers are looking for charging solutions that can seamlessly charge and intuitively connect their light electric personal mobility vehicles from the comfort of their own homes or work. Furthermore, traditional charging stations, whether indoor or outdoor, lack the ability to be modularly configured to accommodate additional docking positions for large numbers of electric light electric personal mobility vehicles.

As such, there exists a need for an improved light electric personal mobility vehicle charging station that addresses the problems identified above. Namely, a modular charging station that can be adjusted to accommodate a variable number of light electric personal mobility vehicles as well as software and hardware interface systems that allow it, or a third party to identify, track, and coordinate multiple light electric personal mobility vehicles within a given space. Moreover, there exists a need for a system that can allow a user, through a personal computer device such as a laptop, cell phone, tablet or other smart-device, to communicate with a light electric personal mobility vehicle and/or charging station to better track the charging status, GPS location, or immobilize the vehicle if so desired.

### SUMMARY OF THE INVENTION

One aspect of the invention includes novel systems, methods, and devices for charging a light electric personal mobility vehicle. Another aspect of the invention includes novel systems, methods, and devices for coupling a light electric personal mobility vehicle with a charging station. Another aspect of the invention includes novel systems, methods, and devices of coordinating one or more light electric personal mobility vehicles.

Another aspect of the invention includes systems, methods, and devices for a modular charging station configured to be expanded or retracted to accommodate and charge a variable number of light electric personal mobility vehicles, and in particular electric two-wheeled, self-balancing, non-tandem light electric personal mobility vehicles. Additional embodiments include a novel vehicle adaptor configured to be coupled to a light electric personal mobility vehicle that is further in electrical communication with the vehicle's battery therewith, that can further be coupled with a receiving dock on a modular charging station that is configured to communicate with, and electrically charge the vehicle's battery from a power supply.

Additional aspects of the invention may become evident in light of the figures and disclosure provided below.

### BRIEF DESCRIPTION OF THE FIGURES

FIG. 1 shows a perspective view of a light electric personal mobility vehicle docked with a modular charging station in one embodiment thereof;

FIG. 2 shows a front perspective view of a modular charging station having a single docking mount in one embodiment thereof;

FIG. 3 shows a top view of a modular charging station securing a cover having an interface module in one embodiment thereof;

FIG. 4 shows a top view of a light electric personal mobility vehicle docked with a modular charging station in one embodiment thereof;

FIG. 5 shows a perspective view of a plurality of personal mobility vehicles docked with a single modular charging station having multiple docking mount positions in one embodiment thereof;

FIG. 6 (A) shows a front perspective view of a modular charging station in one embodiment having a single docking mount in one embodiment thereof; and (B) shows a front perspective view of a plurality of personal mobility vehicles docked with a single modular charging station having multiple docking mount positions in one embodiment thereof;

FIG. 7 shows a front perspective view of a modular charging station having a single modular end cap that is configured to be detachable from a central chassis of a modular charging station in one embodiment thereof;

FIG. 8 shows a front perspective view of a plurality of modular charging stations coupled by a modular extension chassis that is configured to join a plurality of central chassis in one embodiment thereof;

FIG. 9 shows a blown up view of an end cap coupled with a central chassis through a coupler position secured by a plurality of brackets and fasteners in one embodiment thereof;

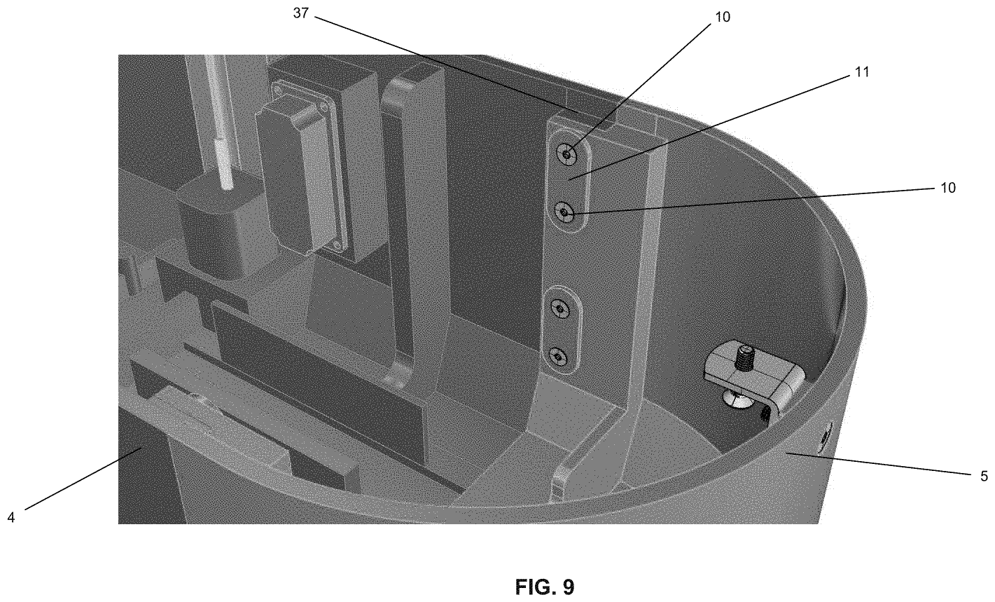

FIG. 10 shows an isolated front perspective view of a vehicle adaptor in one embodiment thereof;

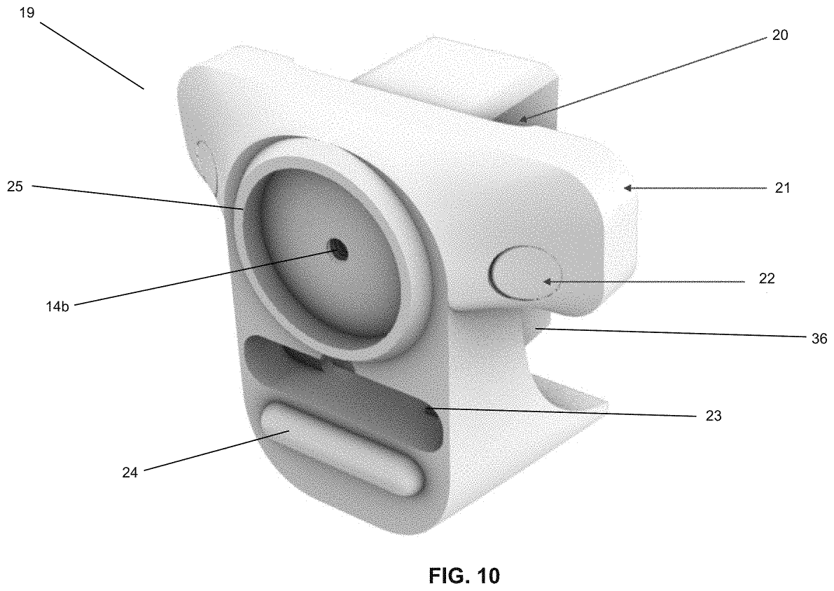

FIG. 11 shows an isolated front perspective view of a receiving dock with a docking cover in one embodiment thereof;

FIG. 12 shows an isolated front perspective view of a receiving dock having a tractable joint in one embodiment thereof;

FIG. 13 shows a cross-sectional view of a receiving dock coupled with a vehicle adaptor in one embodiment thereof;

FIG. 14 shows a step-wise flowchart of a method of using a modular charging station to charge one or more light electric personal mobility vehicles in one embodiment thereof; and

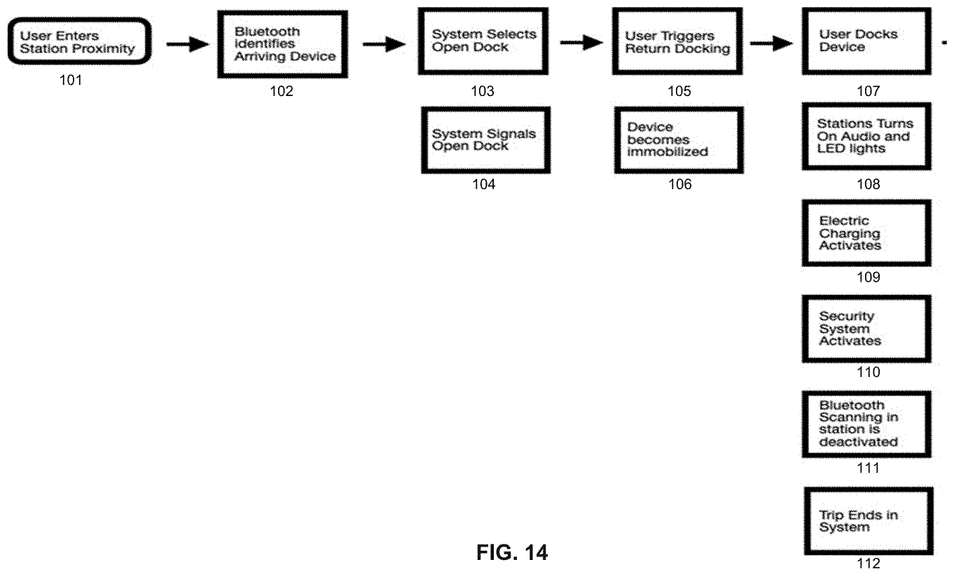

FIG. 15 shows a flowchart of a method of using a modular charging station to charge one or more light electric personal mobility vehicles with a personal computing device in one embodiment; and

FIGS. 16A-B shows (A) a top view of an extended modular charging station coupled by a modular extension chassis having a plurality of microcontrollers responsive to one or more modules; (B) a top view of a modular charging station having a microcontroller responsive to a PCB having one or more modules.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent applications.

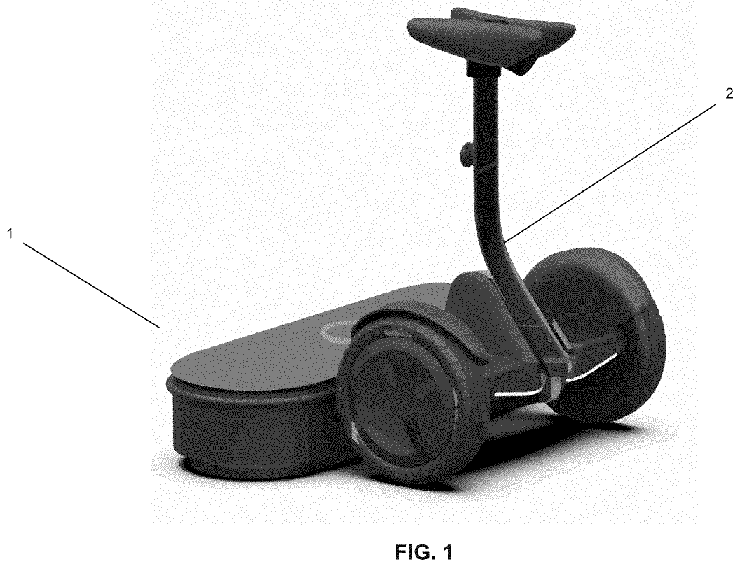

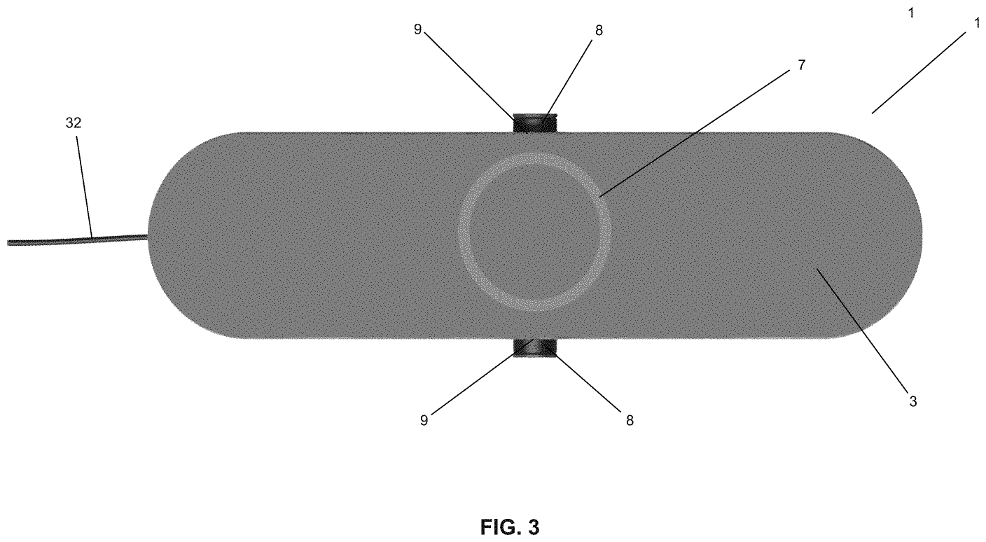

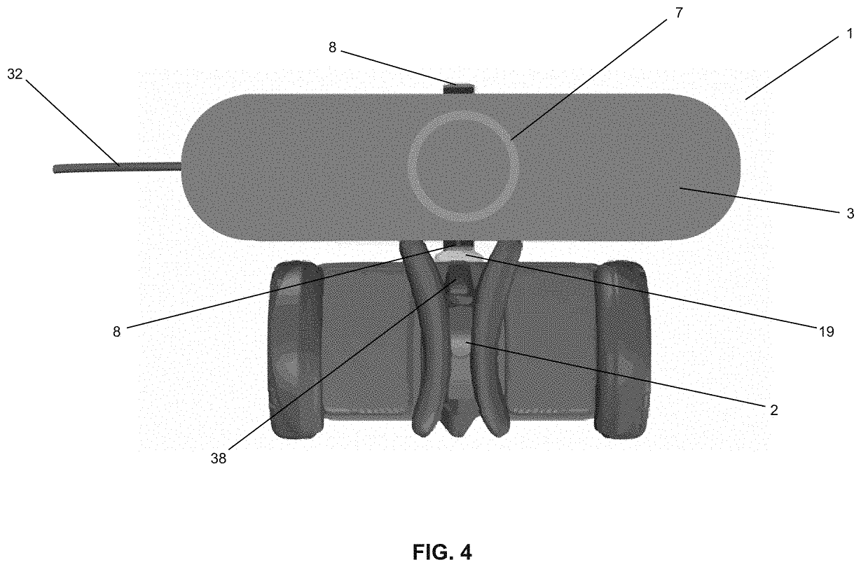

The invention includes system, methods, and devices to charge a light electric personal mobility vehicle (2). In the preferred embodiment shown in FIGS. 1-4, the invention includes a system for charging a light electric personal mobility vehicle (2) from a wired, or wireless power supply (32), such as a standard electrical outlet, battery, generator or other electrical storage and/or transmission device that is in electrical communication with a charging station (1). As used herein, the term “electrical communication” means two or more components of a system that are configured to allow the wired or wireless transmission of an electrical current (also referred to herein as a charge or electrical charge), for example from a power supply (32) to a modular charging station (1) and then to the battery (38) of a personal utility vehicle (2) or data, for example from a microcontroller (40) on a printed circuit board (PCB), or module as described herein. As used herein, personal utility vehicle (2) means an electric vehicle, such as an electric bicycle, an electric scooter, or a two-wheeled self-balancing battery-powered vehicle.

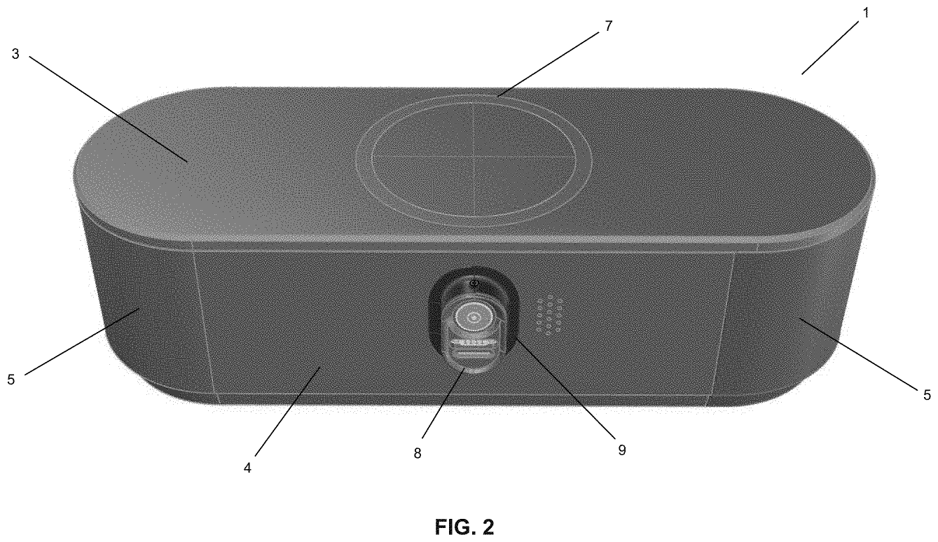

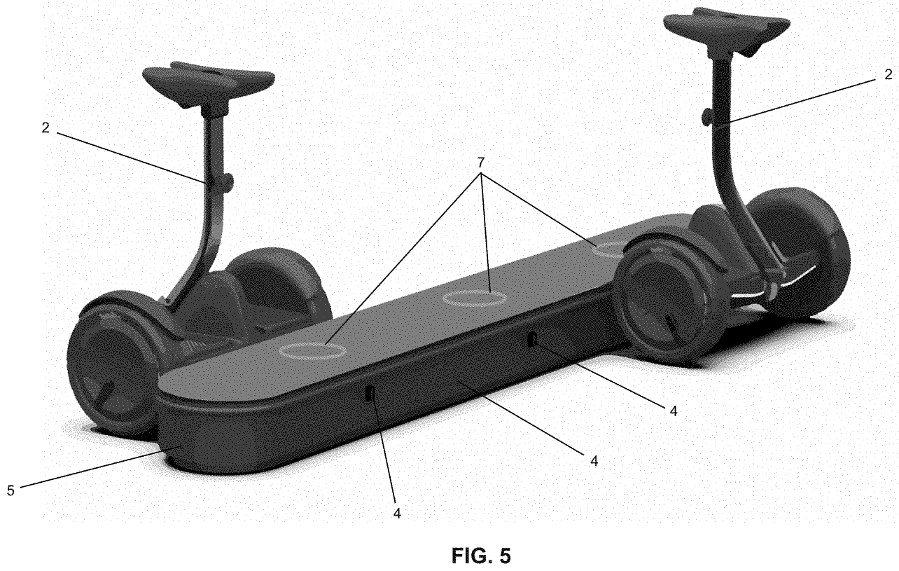

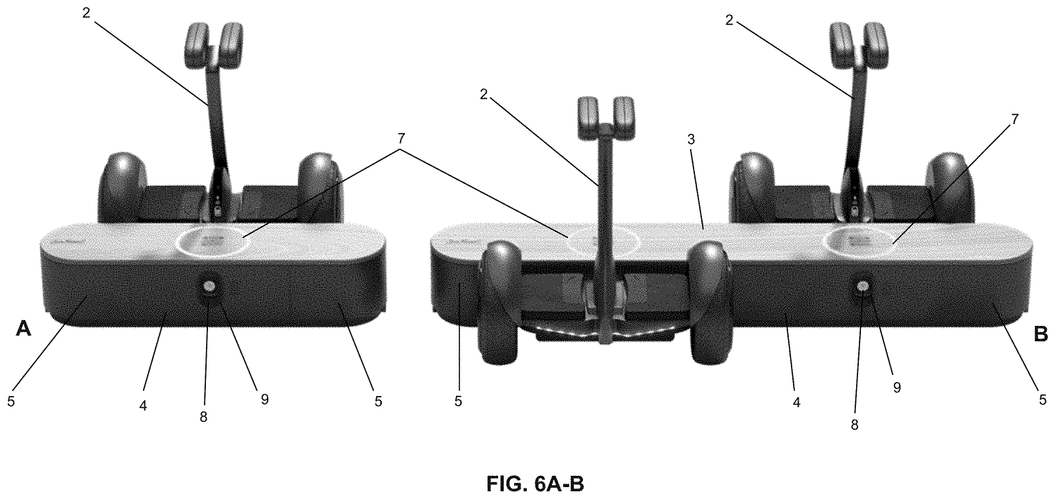

As shown in FIG. 2, a modular charging station (1) of the invention may include a central chassis (4) having a central portion, a bottom surface, and at least a one side wall, which may be an integral or separable component as described in more detail below. The central chassis (4) may be configured to include one or more docking mount positions (9) that may be placed along the side-wall of the central chassis (4) at intervals that accommodate the width of a selected light electric personal mobility vehicle (2). As shown in FIGS. 5-6, a central chassis (4) may include one, or a plurality of docking mount positions (9) that may accommodate a plurality light electric personal mobility vehicle (2). These docking mount positions (9) may further be adjustable along the length of the modular charging station (1) such that they can be adjusted to accommodate a variety of different light electric personal mobility vehicles (2).

As shown in FIGS. 1-6, a modular charging station (1) of the invention may include a cover (3) configured to be positioned over the modular charging station (1) enclosing the internal compartment. In one preferred embodiment, the cover may be coupled with the modular charging station (1) by one or more couplers, such as a snap, slide or quick release coupler that may allow a user to quickly secure and remove the cover (3) from the modular charging station (1). In alternative embodiments, the cover (3) may be coupled with the modular charging station (1) by a hinge or other rotatable joint that may allow a user to open the cover (3) exposing the internal compartment of the central chassis (4). In additional embodiments, a cover (3) of the invention may be secured to the modular charging station (1) by one or more fastener components, such as traditional nut and bolt fasteners, or self-tapping screws and the like. In additional embodiments, the cover (3) of the invention may be expandable to accommodate a plurality of coupled modular charging station (1).

The modular charging station (1) of the invention may further include an interface module (7). In one embodiment, the interface module (7) may be a human machine interface (HMI). This HMI may be positioned on, or a component of the modular charging station (1), while in other embodiments it may be a separable component that may be positioned exterior to the modular charging station (1). As shown in FIGS. 2-4, and 16 the interface module (7) can be position on the cover (3) of the modular charging station (1), such that a user may identify the interface from a distance and from which information can be relayed to a user, or a personal computing device (31) of a user. When a light electric personal mobility vehicle (2) is docked with a modular charging station (1), the interface module (7) of the invention, either directly, or through a detection module (39) responsive to a microcontroller (40), for example on a printed circuit board (41), may detect the engagement of a vehicle (2) and provide a signal, such as an audio, visual, or other electronic signal that can communicate information to a user.

For example, when a light electric personal mobility vehicle (2) is docked with a modular charging station (1), the interface module (7) of the invention, either directly, or through one or more modules, such as a detection module (39), may detect the engagement of the vehicle and activate a signal through the microcontroller (40) to activate a speaker, or one or more lights, such as LED lights to communicate that the device is charging. Alternatively, it may provide a signal, different than the first, that the vehicle is done charging, or even further, a signal, different from the first and second, that displays the level of charge of the vehicle's battery. In another example, a user can manually or automatically preset which visual signal is presented, or whether it is audio, visual, or electronic such as an email, phone or text alert. In another example, when a light electric personal mobility vehicle (2) is in proximity to a modular charging station (1), the interface module (7) of the invention, either directly, or through the microcontroller (40) may detect the presence and/or location of the vehicle (2) and provide an signal, such as an illuminated LED light, directing a user to an open docking mount position (9).

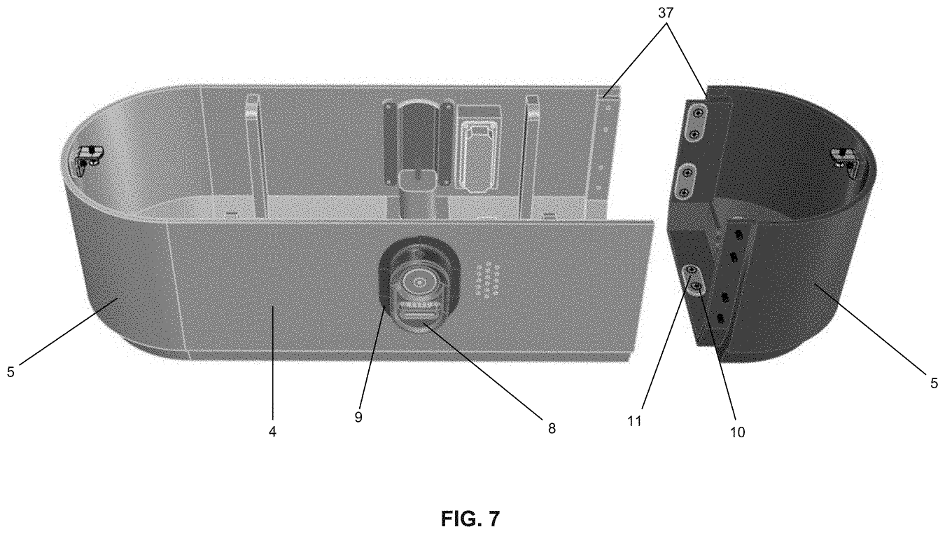

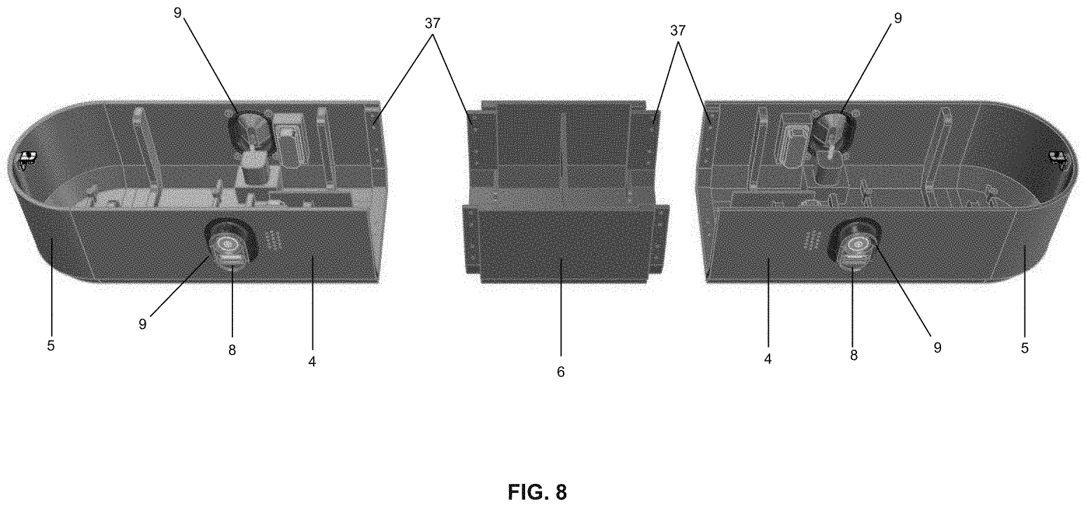

The modular charging station (1) of the invention can be modular such that it may be interconnected with a plurality of modular charging station (1) in series or in a branched configuration. In the preferred embodiment shown in FIGS. 7-8, a modular charging station (1) of the invention may include a central chassis (4) (coupled with one or more modular end caps (5) (also interchangeable referred to end caps). As shown in FIG. 5, a modular end cap (5) may be joined to the terminal end of the central chassis (4) at a coupler position (37). In this configuration, the modular end cap (5) may be disconnected from the central chassis (4) at coupler position (37).

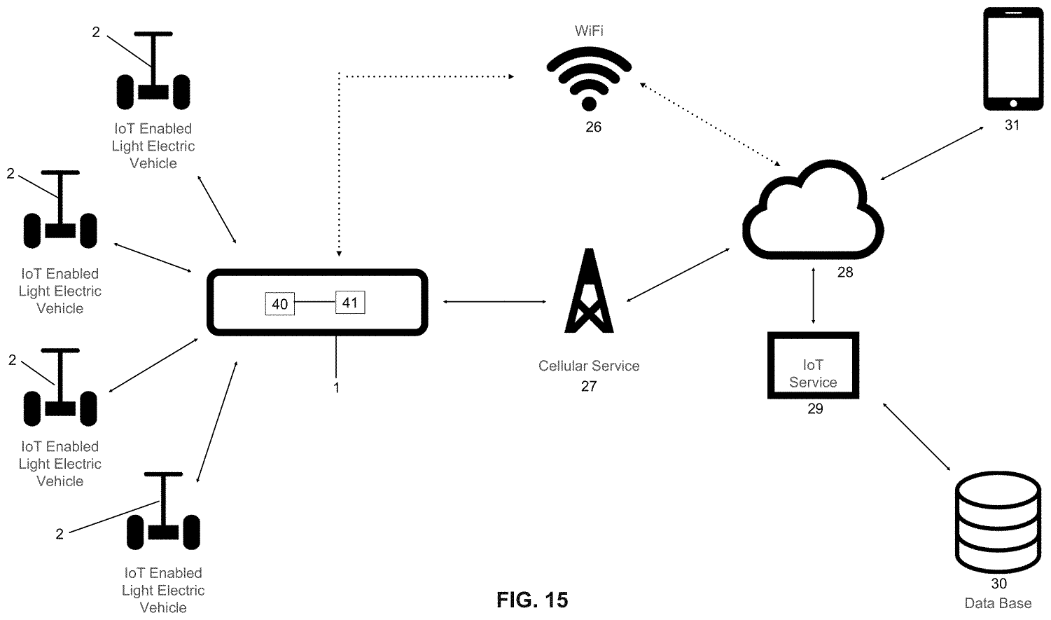

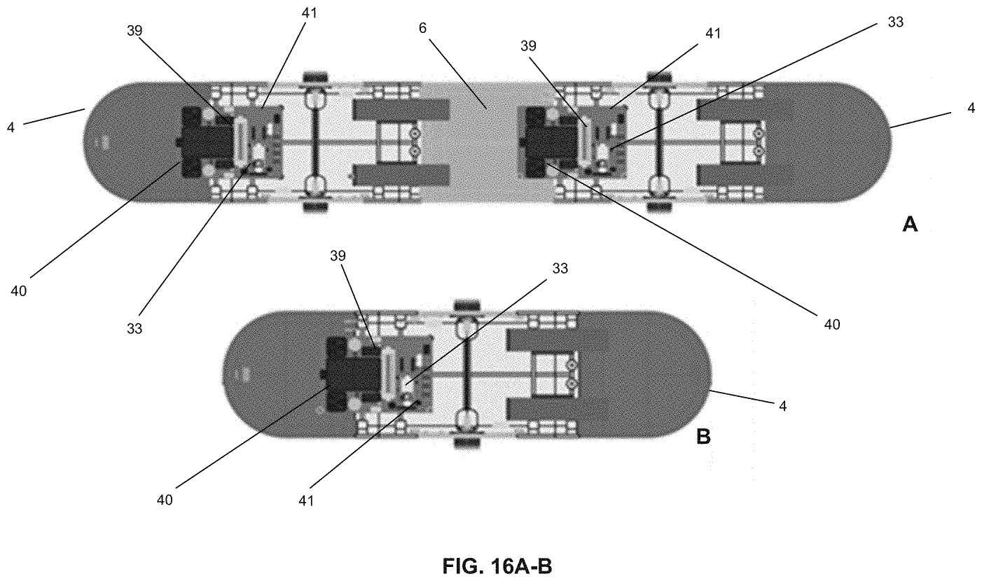

In a preferred embodiment, a central chassis (4) may include a single modular end-cap. As shown in FIG. 8, the central chassis (4) may include a terminal cap, shown as the left terminal side of the chassis, that is continuous with the central portion of the chassis (4). The opposing end of the central chassis (4) may include a detachable modular end cap (5) joined to the central chassis (4) at a coupler position (37). As generally shown in FIGS. 8 and 16, in this preferred embodiment two central chassis (4), each having a terminal cap portion that is integral with the central chassis (4), may be disengaged from their respective modular end caps (5) exposing their coupler positions (37) respectively. These coupled positions may be joined directly or be further coupled with an extension chassis (6) as described below forming an extended modular charging station (1) as shown in FIGS. 8 and 15.

In alternative embodiments, this coupler position (37) may include a separable coupler configured to secure a modular end cap (5) to the central chassis (4) In the embodiment shown in FIG. 7, a coupler position (37) may include a separable bracket (11) and fastener (10) that may further be configured such that a user may access the internal compartment of the central chassis (4), for example by removing the cover (3), and manually removed the bracket (11) and fastener (10). In alternative embodiments, a coupler position (37) may include a coupler that may be separable or integral to the central chassis (4) and modular end cap (5). In this configuration of the invention, a coupler position (37) may include one or more of the couplers selected from the group consisting of: a slide coupler; a snap coupler, and a quick release coupler, or a combination of the same.

In still further alternative embodiments, a coupler position (37) may include a separable or integral joint configured to join a modular end-cap (5) with a central chassis (4). In this configuration of the invention, a coupler position (37) may include one or more of the joints selected from the group consisting of: a fitted joint, a slide joint, a dovetail joint, a pivot joint, and a hinge joint, or a combination of the same.

The internal compartment of a modular charging station (1) may secure one or hardware or software components that are configured to operate the device's features. Generally referring to FIG. 16, in one preferred embodiment a microcontroller (40) on a printed circuit board (40) may include an electronic control unit, which may include a processing system configured to receive, store, or execute computer executable programs or applications to direct one or more functionalities of a modular charging station (1) system. In this preferred embodiment, a microcontroller (40) may be responsive to, and direct the function and operation of modules also located on the printed circuit board, each separately configured to direct the function and/or operation of one or more components of the system. A printed circuit board (also referred to herein as a PCB) (41) may include one or more of the following modules: a power module (33); a docking module (35), an adaptor module (36), and a detection module (39), or a combination of the same.

As detailed below, when a vehicle adaptor (19) and receiving dock (8) are mated, one or more connector pins (12) on the receiving dock (8) are inserted into one or more pin receivers (23) of the vehicle adaptor (19). This connection is detected by the detection module (39) on the printed circuit board (41). The detection module (39) communicates the connection to the microcontroller (40) which is responsive to a power supply (32). Upon confirmation of the connection of the connector pins (12) and pin receivers (23), the microcontroller (40) communicates directly, or indirectly through the printed circuit board, with a power module (33) responsive to a power supply (32) and directs it to transmit an electrical current to the vehicle's battery (38). In this embodiment, the current is routed from a power supply through a wire coupled with one of the connector pins (12), where it is transmitted to the pin receivers (23) which are in electrical communication with the vehicle's battery (38).

In another embodiment, the detection module (39) of the invention may further detect and communicate the connection of the connector pins (12) and pin receivers (23) to the microcontroller (40) which may direct the transfer of data, in this case through a wire coupled with one of the connector pins (12). The data is passed from the connector pins (12) to the pin receivers (23) which is responsive to an adaptor module (36). Alternatively, a microcontroller (40) may direct the transfer of data from an adaptor module (36) to one or more modules of the printed circuit board (41). In some instances, this data may include a software executable command, or vehicle user data generally.

In one preferred embodiment, a microcontroller (40) on the printed circuit board (41) may perform one or more of the following functions, or generate one or more commands, preferably through a module: an electrical charge command; a vehicle charge command; a vehicle charge level data; a vehicle charge history; a vehicle stop-charge command; a vehicle identifier; a vehicle charge history; an executable software application; an executable software application update; a vehicle docking detection command; a vehicle undocking detection command; an authentication command; an authentication request; a vehicle recognition signal; a vehicle availability signal

As noted above, the modular charging station (1) of the invention may be configured to be modular such that a plurality of charging stations can be coupled together and in electrical communication with a single or separate power supplies (32) such that additional light electric personal mobility vehicles (2) can be accommodated, or to allow the modular charging station (1) to be configured to accommodate a specific external environmental or space constraint, or even a preferred design. In one embodiment, an extended modular charging station (1), being generally described as two or more charging stations coupled together, and may be formed by removing a modular end cap (5) from two separate central chassis (4) exposing the coupler position (37) at the terminal ends of each central chassis (4). These coupler positions (37) may be joined thereby coupling the two separate central chassis (4) forming an extended modular charging station (1). As noted above, in one embodiment, when joined, each central chassis (4) may be configured to be in electrical communication with each other and a power supply (32). This continuous single-source power supply may be accomplished through, for example through a physical or wireless electrical connection. In an alternative embodiment shown in FIG. 16A, each central chassis (4) may be in electrical communication with a separate power supply (32), such as through a traditional electrical wall outlet or other appropriate source of electrical power.

As noted above, an extended modular charging station (1) of the invention may include a plurality of central chassis (4) interconnected through one or more extension chassis (6). In the preferred embodiment shown in FIGS. 8 and 16, a modular charging station (1) of the invention may be formed by removing a modular end cap (5) from two separate central chassis (4) exposing the coupler positions (37) at the terminal ends of each central chassis (4). These coupler positions (37) correspond to coupler positions (37) on an extension chassis (6) allowing the separate central chassis (4) to be joined on either end of the extension chassis (6) forming an extended modular charging station (1) that can accommodate more, or larger light electric personal mobility vehicles (2). When joined, an extension chassis (6) may be configured to allow the separate central chassis (4) to be in electrical communication with each other and a power supply (32), for example through a wired connection responsive to one or more printed circuit boards (41). In alternative embodiments, each central chassis (4) may be in electrical communication with a separate power supply (32), such as through a traditional electrical wall plug or other appropriate source of electrical power responsive to each modular charging station's (1) printed circuit board (41).

This continuous single-source electrical connection may be accomplished through a wired connection positioned in each central chassis (4) and extension chassis (6) that are configured to be joined, for example through a manual or automatic female-male electrical connection, such that they are in electrical communication one with another. In alternative embodiments, each central chassis (4) may be in electrical communication with an extension chassis (6) that is in electrical communication with a power supply (32), such as through a traditional electrical wall outlet or other appropriate source of electrical power responsive to a power module (33).

It should be noted that while the extension chassis (6) shown in the embodiment of FIG. 8 is configured to couple two separate central chassis (4), as can be understood from the drawings and specification, multiple central chassis (4) may be coupled together through direct coupling of coupler positions (37) on the separate central chassis (4) components, or through indirect coupling of a plurality of separate central chassis (4) by an extension chassis (6). Also, while the extended modular charging stations (1) of FIG. 8 show multiple central chassis (4) joined in series, this is not a limitation on the scope of the invention. As can be understood from the figures, multiple central chassis (4) may be joined in branched or even parallel configurations, for example through an extension chassis (6) configured to join multiple central chassis (4), or through a shaped extension chassis (6) configured to join multiple central chassis (4) in a branched or parallel configuration. The latter being useful to change the size and orientation of the modular charging station (1) to accommodate indoor or outdoor location constraints, as well as to accommodate different types, sizes, and kinds of light electric personal mobility vehicles (2).

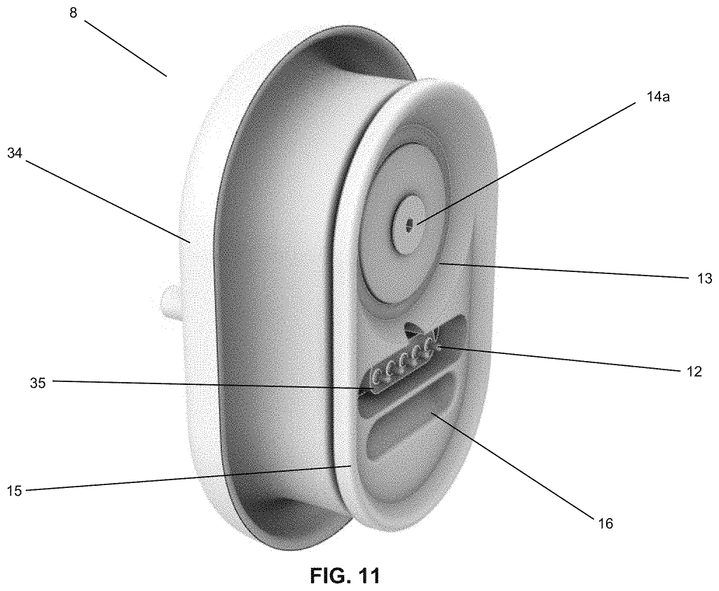

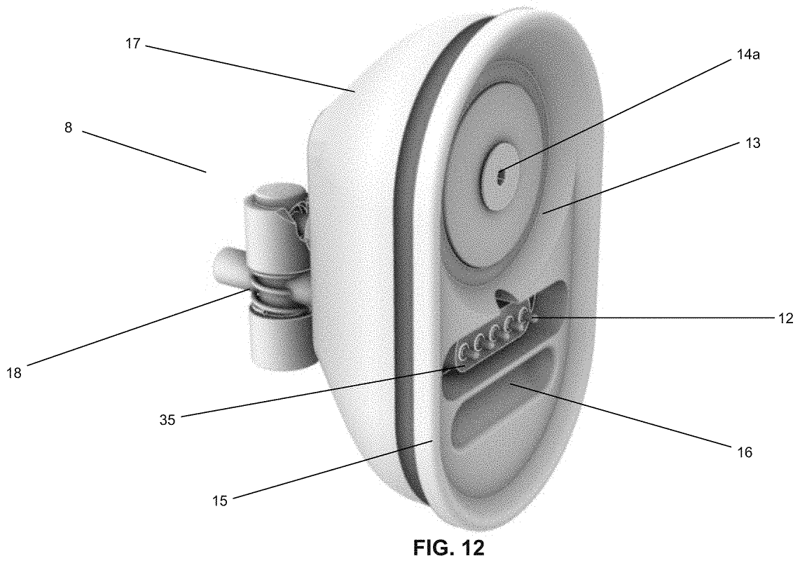

The modular charging station (1) of the invention may include one or more receiving docks (8). In the preferred embodiment shown in FIGS. 2- 4, a receiving dock (8) of the invention may be secured to a docking mount position (9) and may be mated with a corresponding vehicle adaptor (19) secured to a light electric personal mobility vehicle as detailed below. Referring now to FIGS. 11-12, a receiving dock (8) of the invention may include an external housing (17) coupled with a docking chassis (15) that may optionally enclose and secure one or more modules, such as a docking module (35), that may include hardware configured to facilitate the transmission of hardware and or data. The external housing and docking chassis (15) may be separable components, while in alternative embodiments they may be formed as integral single component.

A receiving dock (8) of the invention may further include a docking interface (13) configured to be mated with a corresponding adaptor interface (25) of a vehicle adaptor (19) secured to a light electric personal mobility vehicle (2) as detailed below. In one embodiment, the docking interface (13) may include a magnet (14a), that is magnetically responsive to a corresponding magnet (14b) on a vehicle adaptor (19) such that when brought into proximity the magnetic force generated by the magnets (14a, 14b) directs alignment and engagement of the vehicle adaptor (19) and receiving dock (8). In additional embodiments, the magnet (14a) may be replaced with a metal plate that is magnetically responsive to a corresponding magnet (14b) on a vehicle adaptor (19) such that when brought into proximity the magnetic force generated by the magnet (14b) directs alignment and engagement of the vehicle adaptor (19) and receiving dock (8).

A receiving dock (8) of the invention may further include a mating aperture (16), which in this embodiment is positioned on the external surface of the docking chassis (15) and is also configured to be mated with a mating extension (24) of a vehicle adaptor (19) secured to a light electric personal mobility vehicle (2). Referring again to FIGS. 11-12, a receiving dock (8) of the invention may further include a one or more connector pins (12) which are configured to be mated with one or more pin receivers (23) of a vehicle adaptor (19) secured to a light electric personal mobility vehicle (2). The receiving dock (8) of the invention may further include one or more tractable joints (18) configured to secure the receiving dock (8) to the central chassis (4) of the modular charging station (1). In this configuration, when the receiving dock (8) and vehicle adaptor (19) are mated, a force may be generated by the forward motion of the light electric personal mobility vehicle (2) that can be transmitted through the receiving dock (8) to the tractable joint (18), which in this embodiment includes a ball joint, where it can be dissipate. Further this tractable joint tractable joint (18) allow lateral as well as vertical movement of the receiving dock (8) which allows it to be sufficiently tractable to better align and accommodate the mating with the vehicle adaptor (19).

The modular charging station (1) of the invention may include one or more vehicle adaptors (19) configured to be secured to a light electric personal mobility vehicle (2) and mated with a corresponding receiving dock (8). Referring to FIG. 19, a vehicle adaptor (19) may include an adaptor chassis (20) which may optionally be configured to house and secure one or more modules, such as an adaptor module (36). A vehicle adaptor (19) of the invention may be secured to the external surface of a light electric personal mobility vehicle (2) and may further be configured to be in electrical communication with the vehicle's battery (38) or on-board computer (not shown), for example through an adaptor module (36) configured to be responsive to a microcontroller (40) of a modular charging station (1). In one example, fasteners may be placed through one or more mount apertures (22) and secured to the external surface of a light electric personal mobility vehicle (2), while other embodiments may include a coupler, joint, adhesive, or magnetic coupling configured to secure the vehicle adaptor (19) to a vehicle (2).

Referring again to FIG. 19, in this embodiment a vehicle adaptor (19) may include an adaptor interface (25) configured to be mated with a corresponding docking interface (13) of a vehicle adaptor (19) secured to a docking mount position (9) of a central chassis (4). As noted above, in one embodiment, the adaptor interface (25) may include a magnet (14b), that is magnetically responsive to a corresponding magnet (14a) on a receiving dock (8) such that when brought into proximity the magnetic force generated by the magnets (14a, 14b) directs alignment and engagement of the vehicle adaptor (19) and receiving dock (8). In additional embodiments, the magnet may be replaced with a metal plate that is magnetically responsive to a corresponding magnet (14a) on a receiving dock (8) such that when brought into proximity the magnetic force generated by the magnet (14a) directs alignment and engagement of the vehicle adaptor (19) and receiving dock (8).

Referring again to FIG. 19, in this embodiment a vehicle adaptor (19) may include one or more pin receivers (23) configured to be mated with corresponding connector pin(s) (12) receiving dock (8) and facilitate the transfer of electrical current and/or data. A vehicle adaptor (19) of the invention may further include a mating extension (24), which in this embodiment is positioned on the external surface of the adaptor chassis (20) and is also configured to be mated with a mating aperture (16) of a receiving dock (8). In the configuration, the mating extension (24) may facilitate the alignment and orientation of the receiving dock (8) and help the two components stay mated. Naturally, as can be appreciated, the position of the mating extension (24) and mating aperture (16) can be reversed while providing the same functionality. Moreover, the number and shape of the mating extension (24) and mating aperture (16) can include a variety of various corresponding forms.

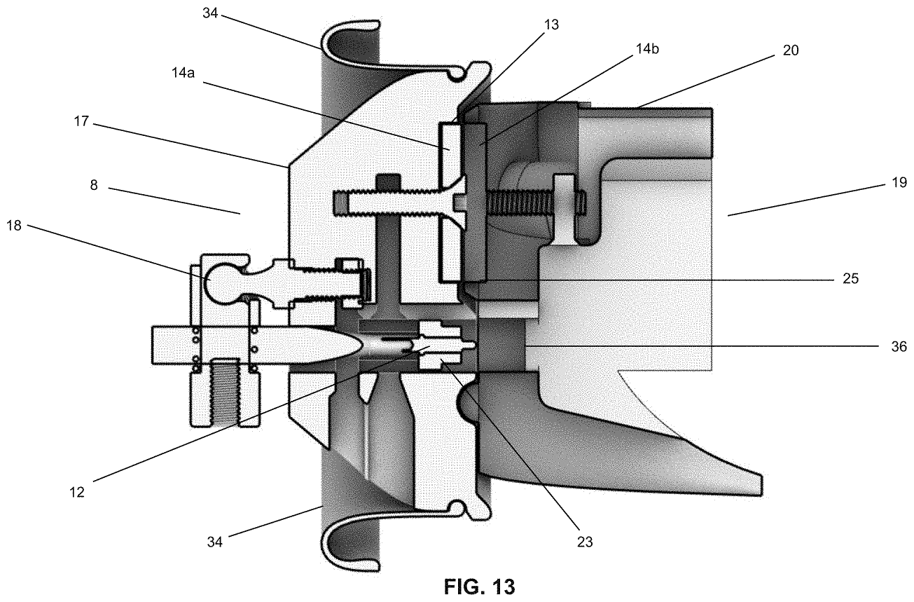

As noted above, a vehicle adaptor (19) and a receiving dock (8) of the invention are configured to be mated and form an electrical communication between a power supply (32) and the battery (38) of a light electric personal mobility vehicle (2). In this preferred embodiment, a power module (33) may be established to regulate the flow of electric current from a power supply (32) or data from a module. This power module (33) may be in electrical communication with said power supply (32) and said receiving dock (8) and further be responsive to a microcontroller (40), installed for example on a printed circuit board(41). Referring now to FIG. 13, a vehicle adaptor (19), secured to a light electric personal mobility vehicle (2), is brought into proximity with a receiving dock (9), such that the connector pins (12) on the receiving dock (8) are inserted into the pin receivers (23) of the vehicle adaptor (19) forming an electrical communication, as well as an electrical connection that allows the transfer of data between one or more modules of the invention, or between the microcontroller (40) and one or more modules of the invention.

As noted above, the engagement of the mating extension (24) and mating aperture (16), as well as the magnets (14a, 14b) may help guide, orientate, and secure the engagement between the vehicle adaptor (19) and a receiving dock (8). Once this engagement has been made, a docking module (35) identifies engagement of the vehicle adaptor (19) with the docking module (35) which is communicated to a microcontroller (40), which in turn directs electrical current from a power supply (32), through the connector pin(s) (12) and pin receiver (23) interface, to the battery (38) of a light electric personal mobility vehicle (2). In a preferred embodiment, the flow of electrical current may be controlled by one or more power modules (33), responsive to the microcontroller (40), and configured to direct the flow of electrical current manually or automatically into the vehicle's battery (38), from a power supply (32) upon engagement of the connector pins (12) and pin receivers (23). This power module (33) may further be optionally responsive to a docking module (35), an adaptor module (36), detection module (39), interface module (7), or another power module (33), or any combination of the same.

The invention described herein further includes systems, methods, and devices to immobilize a light electric personal mobility vehicle (2), while coupled or uncoupled with a charging station (1). In one embodiment, when a vehicle adaptor (19) and a receiving dock (9) are coupled, one or more modules described herein may transmit a signal to the light electric personal mobility vehicle (2) that immobilizes the vehicle until it is released by one or more modules described herein, or a signal provided by a user, through a personal computing device (31). For example, a detection module (39) may identify that the vehicle adaptor (19) and a receiving dock (9) are coupled and provide a immobilization signal that is directed to the vehicle's on-board computer, for example through an adaptor module (36) that is further responsive to the light electric personal mobility vehicle (2), whereby it is immobilized. In another example, a user, and preferably an authenticated user, can send an mobilization signal through a personal computing device (31) to the adaptor module (36) or detection module (39) that causes the vehicle to be mobilized. In another example, a user, through a personal computing device (31), can send a signal, to the adaptor module (36) or detection module (39) that causes the vehicle to be immobilized or mobilized.

In another embodiment, a detection module (39), responsive to a microcontroller (40) may identify that the vehicle adaptor (19) and a receiving dock (9) are coupled and may signal to the light electric personal mobility vehicle (2) to be immobilized or mobilized. Or in another example, a user, and preferably an authenticated user, can send an immobilization signal through a personal computing device (31) to light electric personal mobility vehicle (2) that causes it to be immobilized when a detection module (39) identifies that the vehicle adaptor (19) and a receiving dock (9) are coupled.

The invention described herein further includes systems, methods, and devices to receive, store, or execute computer executable applications. In this preferred embodiment, a user, for example using personal computing device, may receive, store, or execute one or more of the following: vehicle location data; a vehicle charge level data; a user identification; user authentication; a vehicle charge history; a vehicle maintenance history; a vehicle maintenance request; an executable software application; an executable software application update; an authentication command; an authentication request; a vehicle immobilization command; a vehicle on-signal; and a vehicle-off signal.

The invention described herein further includes systems, methods, and devices to receive, store, or execute computer executable applications from a third party system or network. In this preferred embodiment, a third party system, communicated with a modular charging station (1) and may receive, store, or execute one or more of the following: an electrical charge; a vehicle charge command; a vehicle stop-charge commend; a vehicle location data; a vehicle charge level data; a vehicle identifier; a user identification; a vehicle charge history; a vehicle maintenance history; an executable software application; an executable software application update; a vehicle docking command; a vehicle undocking command; an authentication command; an authentication request; a vehicle recognition signal; a vehicle immobilization command; a vehicle availability signal; a vehicle on-signal; and a vehicle-off signal.

The invention further includes systems, methods, and devices to coordinate one or more light electric personal mobility vehicles (2) within a pre-determined area. In a preferred embodiment, one or more charging stations, and preferably modular charging stations (1), may be configured to generate, or access a wide-area connectivity (WAN) or wireless-local-area network (WLAN) connectivity system or Personal Area Network (PAN) responsive to a plurality of light electric personal mobility vehicles (2). In this embodiment, WAN or WLAN or PAN connectivity responsive to a plurality of light electric personal mobility vehicles may be generated by one or more of the following: a wireless signal; a wi-fi signal, a cellular signal; a Global System for Mobile Communications (GSM)system, Code-division Multiple Access (CDMA) system, a Bluetooth system, and a Zigbee, system , a signal between 2.4/5 GHz, signal, and a signal between 700 MHz-2.9 GHz.

The modular charging station (1) system of the invention is further configured to send and receive wireless signals within an area so as to be in wireless communication with a plurality of light electric personal mobility vehicles (2). In a preferred embodiment, a modular charging station (1), responsive to a microcontroller (40), of the invention may be wirelessly responsive to an adaptor module (36) that is responsive to the controls of a light electric personal mobility vehicles electric personal mobility vehicle (2). The detection module (39) of the invention may further be in wired, wireless connection with, or responsive to at least one remote server (28). This remote server may be a physical, or cloud-based server and may further be responsive to a database or IoT Service configured to store one or more executable parameters for the light electric personal mobility vehicles (2) associated with that system. Such executable parameters may include executable commands, user information, as well as vehicle information specific to a light electric personal mobility vehicle (2), as well as authentication and encryption parameters associate with a user of light electric personal mobility vehicle (2).

As shown in FIG. 15, in one embodiment a personal computing device (31) may operate a computer executable application allowing wireless communication with a database (30) or IoT Service (29) that may store, transmit or coordinate one or more executable parameters for the light electric personal mobility vehicles (2) that may further be communicated to a microcontroller (40) of modular charging station (1). In another embodiment, a personal computing device (31) may include a computer executable application allowing wireless communication with a modular charging station (1)such that the light electric personal mobility vehicles (2) are wirelessly responsive to the personal computing device (31) through said WAN or WLAN connectivity, such as a Bluetooth® connection, generated by a charging station (1).?

In the embodiments described above, a user, through a personal computing device (31) can transmit, and preferably wirelessly transmit, one or more executable commands to one, or a plurality of light electric personal mobility vehicles (2) associated with a charging station (1), or within a pre-determined area. In certain embodiments, this executable command may include: vehicle location data; a vehicle charge level data; a user identification; user authentication; a vehicle charge history; a vehicle maintenance history; a vehicle maintenance request; an executable software application; an executable software application update; an authentication command; an authentication request; a vehicle immobilization command; a vehicle on-signal; and a vehicle-off signal.

The invention further includes methods and procedures for coordinating the charging of one or more light electric personal mobility vehicles (2). In one embodiment, one or more charging stations, and preferably one or more modular charging stations (1), may be positioned within a pre-defined area, and further configured to be responsive to one or more light electric personal mobility vehicles (1) within a pre-determined proximity, which may be defined by the coverage area of an WAN or WLAN connectivity system. In certain embodiments, a vehicle identification is generated by one or more of the following: a wireless signal; a wi-fi signal, a cellular signal; a Global System for Mobile Communications (GSM)system, Code-division Multiple Access (CDMA) system, a Bluetooth system, and a Zigbee, system , a signal between 2.4/5 GHz, signal, and a signal between 700 MHz-2.9 GHz.

Next, a light electric personal mobility vehicle (2) within said station's proximity is identified, preferably through a signal from an adaptor module (36) to the microcontroller (40) of a modular charging station (1). This signal may be direct, or indirect such that is transmitted through one or more modules or the microcontroller (40). In one preferred embodiment, a light electric personal mobility vehicle (2) within said station's proximity is identified by a stations' microcontroller (40) Bluetooth system, and in particular a Bluetooth low energy protocols.

Next, the microcontroller (40), through a detection module (39) or a docking module (35) may identify, through a wide-area connectivity (WAN) or wireless-local-area network (WLAN) system or through a wired connection, an open charging docking position, herein described as an unoccupied receiving dock (8) or other docking mount position (9) configured to engage and charge a light electric personal mobility vehicle (2). In certain embodiments, a WAN or WLAN connectivity system is generated by one or more of the following: a wireless signal; a wi-fi signal, a cellular signal; a Global System for Mobile Communications (GSM)system, Code-division Multiple Access (CDMA) system, a Bluetooth system, and a Zigbee, system , a signal between 2.4/5 GHz, signal, and a signal between 700 MHz-2.9 GHz.

Next, the microcontroller (40), through detection module (39) or a docking module (35) of a modular charging station (1) may activate the open charging docking position and may further activate an interface module (7), for example through execution of a computer executable code, to indicate that the open charging docking position on the charging station (1) is active. As noted above, this indication may be through a visual or audio signal, or even an electronic signal, such as an electronic message, such as a text or email, to a user's personal computing device (31). A user may now dock a light electric personal mobility vehicle (2) with said open charging docking position establishing an electrical communication between the charging station (1) and battery (38) of the vehicle (2). As noted above, this step of docking can be accomplished through the physical mating of a receiving dock (8) and a vehicle adaptor (19) of a vehicle.

Next, one or more modules, and preferably a detection module (39) or a docking module (35), communicates an immobilization command from a microcontroller (40), through execution of a computer executable code, to the light electric personal mobility vehicle (2). In this immobilized state, the light electric personal mobility vehicle (2) can be charged, for example by the execution of a computer executable code by one or more modules, and preferably a power module (33) responsive to a power supply (32) and microcontroller (40). In some embodiments a vehicle (2) may be allowed to charge in this immobilized state until released by a user, or automatically once the vehicle (2) has reached a target level of battery (38) charge. In this immobilized state the system may activate a security system wherein the vehicle (2) can only be released from the immobilized state by an authenticated user. In one embodiment, a user can be authenticated through a personal computer device (31), for example by registering or being provided access to one or more light electric personal mobility vehicles (2) within a pre-determined area or group. In this embodiment, a user and/or light electric personal mobility vehicles (2) may be authenticated through assignment of a unique identifier, such as a unique numerical identifier.

The system may include the step of activating an interface module (7) that may provide a visual, audio or electronic signal, that can, for example indicate that the light electric personal mobility vehicle (2) is partially or fully charged. Once the light electric personal mobility vehicle (2) has reached a pre-determined level of charge, a charging station (1), for example through a wireless signal generated by a microcontroller (40) and transmitted to an interface module (7), may indicate to a user that the light electric personal mobility vehicle (2) is, for example, fully charged and ready for use. Finally, once the light electric personal mobility vehicle (2) has reached a pre-determined level of charge, a charging station (1) a microcontroller (40) may transmit a signal to a power module (33) to stop the vehicle charging process.

Naturally as can be appreciated, all of the steps as herein described may be accomplished in some embodiments through any appropriate machine and/or device, such as a module, resulting in the transformation of, for example data, data processing, data transformation, external devices, operations, and the like. It should also be noted that in some instance's software and/or software solution may be utilized to carry out the objectives of the invention and may be defined as software stored on a magnetic or optical disk or other appropriate physical computer readable media including wireless devices and/or smart phones, smart devices, tablets and the like. In alternative embodiments the software and/or data structures can be associated in combination with a computer or processor, such as a module, that operates on the data structure or utilizes the software. Further embodiments may include transmitting and/or loading and/or updating of the software on a computer module perhaps remotely over the internet or through any other appropriate transmission machine or device, or even the executing of the software on a computer module resulting in the data and/or other physical transformations as herein described.

Certain embodiments of the inventive technology may utilize a machine and/or device, such as a module, which may include a general purpose computer, a computer that can perform an algorithm, computer readable medium, software, computer readable medium continuing specific programming, a computer network, a server and receiver network, transmission elements, wireless devices and/or smart phones, internet transmission and receiving element; cloud-based storage and transmission systems, software updatable elements; computer routines and/or subroutines, computer readable memory, data storage elements, random access memory elements, and/or computer interface displays that may represent the data in a physically perceivable transformation such as visually displaying said processed data. In addition, as can be naturally appreciated, any of the steps as herein described may be accomplished in some embodiments through a variety of hardware applications including a keyboard, mouse, computer graphical interface, voice activation or input, server, receiver and any other appropriate hardware device known by those of ordinary skill in the art.

As used herein a module may include a “processor,” “processor system,” or “processing system,” which includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

For the sake of brevity, conventional techniques related to computer programming, computer networking, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary”, “embodiment” or “preferred embodiment” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

1. A system for charging a light electric personal mobility vehicle comprising:
a power supply;
a first charging station having:
a central chassis;
at least one modular end-cap coupled with the terminal end of said central chassis;
a coupler position joining said modular end-cap and said central chassis;
at least one docking mount position;
at least one interface module; and
a cover positioned over said central chassis;
a microcontroller responsive to a printed circuit board (PCB), said PCB having:
a power module in electrical communication with said power supply; and
a detection module;
at least one a receiving dock having a docking module responsive to said microcontroller;
at least one vehicle adaptor secured to a light electric personal mobility vehicle, having an adaptor module in electrical communication with the battery or on-board computer of said light electric personal mobility vehicle, and further configured to engage said receiving dock; and
wherein said detection module communicates to said microcontroller the engagement of said vehicle adaptor with said docking module, and wherein said microcontroller signals to said power module to transmit data or an electrical charge from said power supply to the on-board computer or battery of said vehicle.

2. The system of claim 1, wherein said at least modular one end-cap can be de-coupled from said central chassis such that said central chassis can be coupled with a second central chassis through an extension chassis.

3-6. (canceled)

7. The system of claim 1, wherein said interface module comprises a human machine interface (HMI).

8. (canceled)

9. The system of claim 1, wherein said first charging station is configured to remove both modular end-caps and be joined with a second and third charging station forming an extended modular charging station having a plurality of docking mount positions configured to charge a plurality of light electric personal mobility vehicles.

10. (canceled)

11. The system of claim 1, wherein said coupler position is selected from the group consisting of: a slide coupler; a snap coupler, a quick release coupler, a bracket and fastener; a nut and bolt connection; a fastener, a fitted joint, a slide joint, a dovetail joint, a pivot joint, and a hinge joint.

12. The system of claim 1, wherein said receiving dock comprises a receiving dock having:
a housing;
one or more of connector pins responsive to a microcontroller;
a docking chassis having a docking interface configured to be coupled with said vehicle adaptor;
a mating aperture; and
a tractable joint coupled with said central chassis.

13-15. (canceled)

16. The system of claim 1, wherein said light electric personal mobility vehicle is selected from the group consisting of: an electric bicycle, an electric scooter, and a two-wheeled self-balancing battery-powered vehicle.

17. The system of claim 1, and further comprising an immobilization signal sent by said microcontroller to the on-board computer of the vehicle when said detection module confirms to said microcontroller the engagement of said vehicle adaptor with said docking module.

18. The system of claim 17, wherein the immobilized light electric personal mobility vehicle can be wirelessly mobilized from a signal provided by a personal computing device.

121. (canceled)

22. A system for coupling a light electric personal mobility vehicle with a charging station comprising:
a microcontroller responsive to a printed circuit board (PCB), said PCB having:
a power module in electrical communication with power supply; and
a detection module;
a receiving dock coupled with a charging station having:
a docking chassis having a docking interface;
one or more of connector pins configured to transmit data or an electrical charge;
a mating aperture; and
a docking module responsive to said microcontroller;
a light electric personal mobility vehicle;
a vehicle adaptor configured to be coupled with said light electric personal mobility vehicle having:
an adaptor chassis having an adapter interface configured to be coupled with said docking interface;
a mating extension configured to be coupled with said mating aperture;
an adaptor module in electrical communication with the battery or on-board computer of said light electric personal mobility vehicle, and further configured to engage said receiving dock; and
a plurality of pin receivers responsive to said adaptor module and configured to accept said connectors pins and form a responsive electrical communication between said microcontroller and said adaptor module.

23. (canceled)

24. The system of claim 22, wherein said adapter interface comprises an adapter interface securing a magnet.

25. The system of claim 22, wherein said docking interface comprises a docking interface securing a magnet.

26. The system of claim 22, wherein said docking module is responsive to said microcontroller and said power supply through a power module.

27. The system of claim 22, and further comprising a tractable joint coupling said receiving dock with said charging station.

28. The system of claim 22, wherein said charging station comprises a modular charging station.

29. The system of claim 22, wherein said light electric personal mobility vehicle is selected from the group consisting of: an electric bicycle, an electric scooter, and a two-wheeled self-balancing battery-powered vehicle.

30. The system of claim 22, and further comprising a dock cover secured to said receiving dock.

31. The system of claim 22, and further comprising an interface module responsive to said microcontroller.

32. (canceled)

33. The system of claim 22, wherein said electrical communication between said docking module and said adaptor module is selected from the group consisting of: an electrical charge; a vehicle charge command; a vehicle charge level data; a vehicle charge history; a vehicle stop-charge command; a vehicle identifier; a vehicle charge history; an executable software application; an executable software application update; a vehicle docking detection command; a vehicle undocking detection command; an authentication command; an authentication request; a vehicle recognition signal; a vehicle availability signal.

34-51. (canceled)

52. A system for charging a light electric personal mobility vehicle comprising:
a power supply;
a first charging station having:
a central chassis;
at least one docking mount position;
at least one interface module; and
a cover positioned over said central chassis;
a microcontroller responsive to a printed circuit board (PCB), said PCB having:
a power module in electrical communication with said power supply; and
a detection module;
at least one a receiving dock having a docking module responsive to said microcontroller;
at least one vehicle adaptor secured to a light electric personal mobility vehicle, having an adaptor module in electrical communication with the battery or on-board computer of said light electric personal mobility vehicle, and further configured to engage said receiving dock; and
wherein said detection module communicates to said microcontroller the engagement of said vehicle adaptor with said docking module, and wherein said microcontroller signals to said power module to transmit data or an electrical charge from said power supply to the on-board computer or battery of said vehicle.

53. The system of claim 1, wherein said at least modular one end-cap can be de-coupled from said central chassis such that said central chassis can be coupled with a second central chassis through an extension chassis.
